(19) United States
(12) Patent Application Publication
(10) Pub. No.: US 2019/0331291 A1
(43) Pub. Date: Oct. 31, 2019

(54) Versatile Article Support Device

(71) Applicant: Alan Stanley Poudrier, Niceville, FL (US)

(72) Inventor: Alan Stanley Poudrier, Niceville, FL (US)

(21) Appl. No.: 15/962,262

(22) Filed: Apr. 25, 2018

(51) Int. Cl. F16M 11/38; F16M 11/42

(52) U.S. Cl. CPC F16M 11/38; F16M 11/42

(57) ABSTRACT

An article support device that can be arranged in a plurality of architectures to suit the user's needs and can be easily collapsed for storage and/or transported within a vehicles cargo area. The article support device uses a horizontal frame member with a plurality of positions to receive one or more vertical frame members that can be secured into desired positions. The frame members may also be arranged in an architecture to support a raised platform by attaching two or more vertical frame members to the horizontal frame member. The assembled frame members can become a rigid structure by adding frame supports in appropriate fashion. Hinge pin receivers may be attached to the vertical frame members. The hinge pin receivers accept the hinge pins that are attached to SUV doors. When the hinge pins of SUV doors are aligned with the hinge pin receivers on a vertical frame member, the SUV doors can be secured to the article support device by lowering the SUV doors and hinge pins into the hinge pin receivers until the doors are in a position resting on the horizontal frame section the article support device.

### BRIEF DESCRIPTION OF THE DRAWINGS

FIG. 1 is a perspective view of the versatile article support device in an open position.

FIG. 2 is a perspective view of the versatile article support device in a collapsed position.

FIG. 3 is a perspective view of the versatile article support device in an open position, illustrating alternative construction materials

FIG. 4 is an environmental view of the versatile article support device supporting a platform, sink, and barbeque grill.

FIG. 5 is a perspective view of the hinge pin receiver.

FIG. 6 is an environmental view of the hinge pin receivers attached to the versatile article support device supporting SUV doors.

Similar reference numerals refer to similar parts throughout the several views of the drawings.

### BACKGROUND OF THE INVENTION

### 1. Field of the Invention

The present invention relates to a versatile device that can support articles in a range of positions and a variety of applications as defined by the needs of the user. The device may be easily attached to an object such as a vehicle or building when utilized for stationary support of articles, or the device may be arranged into a free-standing position and support articles independently of structures of other objects. Wheels or casters may be easily attached to the device enabling the user to move the device and articles being supported to a desired location.

### 2. Background of the Prior Art

Many people who enjoy outdoor activities own sport utility vehicles (SUVs) with doors that can be removed in order to give occupants more outdoor pleasure while riding in the vehicle with doors removed. Some devices are available for storing the doors, but such devices do not offer any purpose beyond this singular function and are they are not readily available for use when the SUV owner is away from home. The devices also take up space when they space when they are not being utilized for their intended purpose. Owners of SUVs with removable doors find that they simply lack a compact device which is easy to transport and will support the removable SUV doors at their outdoor recreation destination. Owners of bulky devices that support and store the removable SUV doors have little or no use for the device when the doors are not removed.

Accordingly, there is a need in the art for a device that can increase the overall utility of a SUV door holder so that device has substantial utility to a user beyond the primary function. Such a device must provide support for a variety of articles as defined by the users' needs and also be collapsible when the device is not being utilized for easy storage or transport of the device via the limited cargo area of a vehicle. Such a device must be of relatively simple construction and be easy to use.

### SUMMARY OF THE INVENTION

The versatile article support of the present invention addresses the aforementioned needs in the art by providing a device that is relatively small in size such that it can be transported within the cargo area of most midsize SUVs and even many compact vehicles. The device is primarily comprised of rectangular frame members that can quickly be secured to an open position and readily support a variety of articles based on the user's needs. Spaced apart holes passing from the bottom side to the top side of each frame member allow the user to insert bolts, eyebolts, or hooks through the frame members to secure articles as defined by the user's needs. Casters can also be inserted into the holes in the frame members in order to provide mobility of the article support device.

For example, the article support device can be transported in the cargo area of a vehicle in the collapsed positon. Upon arrival at a destination a user can position the article support framework such that the second frame member will be at a 90 degree angle with respect to the first frame member. Hinge pin receivers can be inserted in the appropriate holes in the second frame member to align with the hinge pins of the SUV door. An individual who removes the doors from the SUV secures the doors on the article support device by aligning the door's hinge pins to the hinge pin receivers on the second frame member.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

### BRIEF DESCRIPTION OF THE DRAWINGS

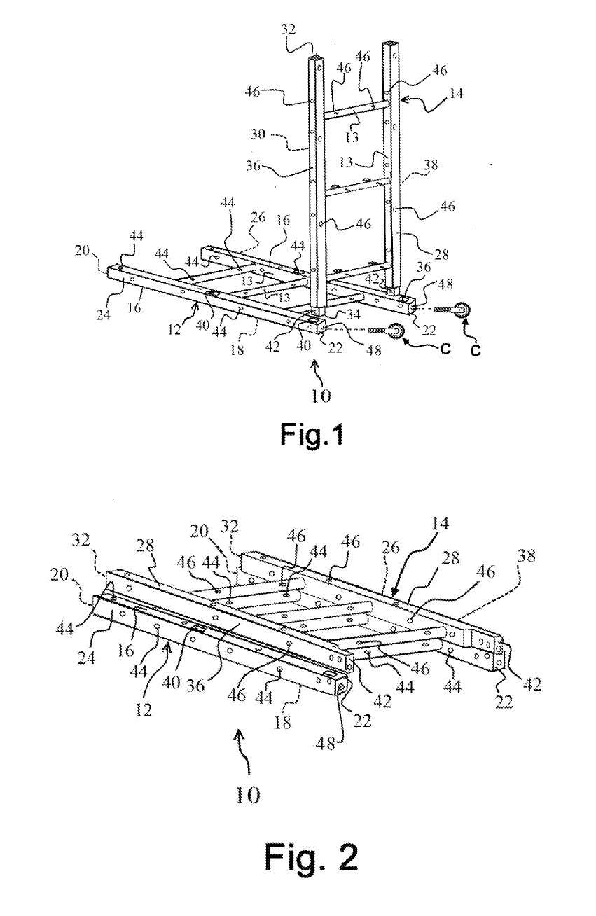

FIG. 1 is a perspective view of the article support receiver in an open position.

FIG. 2 is a perspective view of the article support receiver in a collapsed position.

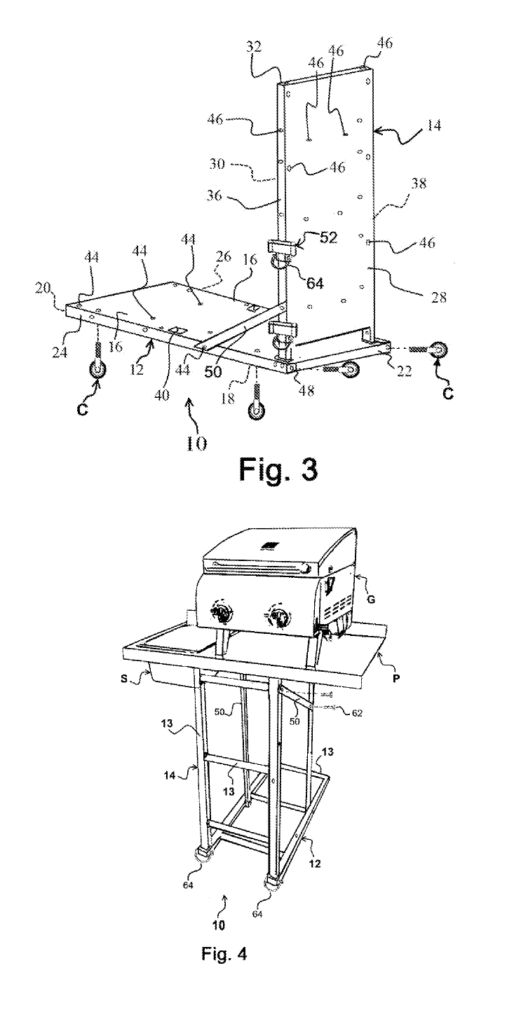

FIG. 3 is a perspective view of the article support receiver in an open position, illustrating alternative construction materials

FIG. 4 is an environmental view of the article support receiver supporting a platform, sink, and barbeque grill.

FIG. 5 is a perspective view of the hinge pin receiver.

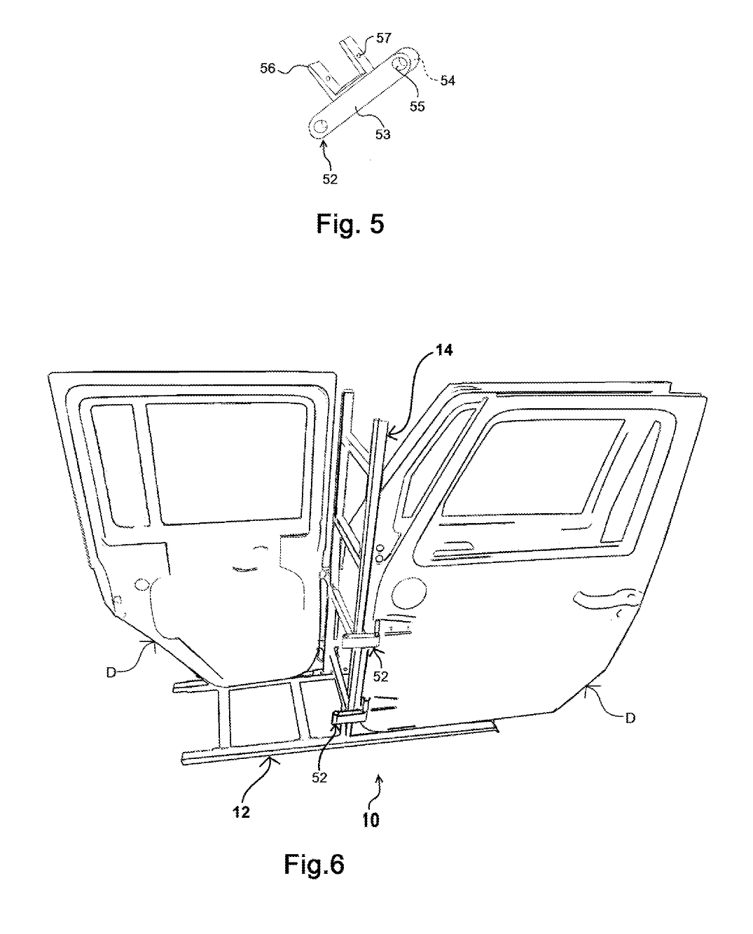

FIG. 6 is an environmental view of the hinge pin receivers attached to the versatile article support device supporting SUV doors.

Similar reference numerals refer to similar parts throughout the several views of the drawings.

### DESCRIPTION OF THE PREFERRED EMBODIMENT

Referring now to the drawings, it is seen that the article support device of the present invention, generally denoted by reference numeral 10, is comprised of a generally rectangular shaped first frame member 12, and a generally rectangular shaped second frame member 14. The first frame member 12 and the second frame member 14 may be fabricated with tubular and/or flat bar components 13 appropriately joined together (i.e.: welded or bonded) to form the rectangular shaped frame members. As illustrated in FIG. 3 frame member 12 and frame member 14 may be alternatively be fabricated with singular piece of wood, plastic, or other composite material.

The first frame member 12 having a first top side 16 and a first bottom side 18. The first frame member 12 also having a first end 20 and a second end 22, the first frame member 12 also having a first side 24 and a second side 26. The second frame member 14 having a second top side 28 and a second bottom side 30 , the second frame member 14 also having third end 32 and a fourth end 34. The second frame member 14 also having a third side 36 and a fourth side 38.

The first frame member 12 of the article support device 10 also having a plurality receiving sockets 40 wherein, the fourth end 34 of second frame member 14 having appendages 42. The appendages 42 can be inserted into the receiving sockets 40 in a variety of positions to suit the user's needs.

The second end 22 of the first frame member 12 having second end holes 48 to allow the user to insert casters C into second end holes 48.

The article support device 10 also having a plurality of first hardware holes 44 in the first frame member 12, and the article support device 10 also having a plurality of second hardware holes 46 in the second frame member 14;

The first hardware holes 44 located in the first frame member 12 and second hardware holes 46 may be threaded or the first hardware holes 44 and second hardware holes 46 may void on threads allowing bolts 62 or spring pins 64 to be inserted into one or more of the hardware holes 44 and/or hardware holes 46 and pass through the first frame member 12 and/or the second frame member 14. Frame supports 50 can be positioned at appropriate angles and attached to first frame member 12 and second frame member 14 allowing a user to arrange the frame members to be positioned and secured in a variety of architectures as seen with a platform P, barbeque grill G, and sink S supported by versatile article support device 10.

A plurality of hinge pin receivers 52 may be attached to the second fame member 14 to support SUV doors D when they are removed from the vehicle. The hinge pin receivers 52 having a top side 53 and a bottom side 54 and also having one or two holes 55 passing through the hinge pin receivers 52 from the top side 53 to the bottom side 54. The hinge pin receivers 52 also having a mounting bracket 56 attached to the hinge pin receivers 52 with appropriate method (bolts, bonding, or welding), the mounting brackets having securement holes 57 passing through the mounting bracket 56.

While the invention has been particularly shown and described with reference to an embodiment thereof, it will be appreciated by those skilled in the art that various changes in form and detail may be made without departing from the spirit and scope of the invention.

1. A versatile article support device comprising:
a first frame member and a second frame member, wherein;
the first frame member having a first top side and a first bottom side, the first frame member also having a first end and a second end, the first frame member also having a first side and a second side; and the second frame member having a second top side and a second bottom side, the second frame member also having a third end and a fourth end, the second frame member also having ;a third, side and a fourth side, wherein,
the fourth end of the second frame member may be held vertically and inserted in the horizontally positioned first frame member in a user selected receiving socket and secured in an angled position with respect to the first frame member;
the article support device also having a plurality of first holes in the first frame member, wherein; the first holes are arranged in spaced apart relationship to a plurality of second holes in the second frame member such that the first holes in the first frame member align with the second holes in the second frame member when the second frame member is positioned onto the first top side of the first frame member in a collapsed position; and
1 hinge pin receiver with a u-shaped mounting bracket where the U-shaped mounting bracket is selectively attachable along the second frame member such that the hinge pin receiver extends to both sides of the second frame member wherein the hinge pin receiver includes a hole on both sides of the second frame member said holes configured to receive and retain a hinge pin.

2. The versatile article support device as in claim 1 wherein the first side of the first an member has a plurality of hardware holes located in the first side of the first frame member and hardware holes also located in the second side of the first frame member allowing bolts to be inserted into one or more of the hardware holes on the first side of the first frame member and pass through the hardware holes of the first frame member to the second side of the first frame member.

3. the versatile-article support device as in claim 1 wherein the first frame member has a plurality of hardware holes in the first top side of the first frame member, wherein said hardware holes pass through the first frame member to the first bottom side of the first frame member.

4. The versatile article support device as in claim 1 wherein the second end of the first frame member has hardware holes configured to receive and retain casters.

5. The versatile article support device as in claim 1 where the second top side of the second frame member has plurality of hardware holes located in the second top side of the second frame member, wherein said hardware holes pass through the second frame member to the second bottom side of the second frame member.

6. The versatile article support device as in claim 1 wherein the third side of the second frame member as a plurality of hardware holes located in the third side of the second frame member, wherein said hardware holes also located in the fourth side of the second frame member, allowing bolts to be inserted into one or mote of the hardware holes on the third side of the second frame member and pass through the second frame member to the fourth side of the second frame member.

7. The versatile article support device as in claim 1 wherein the hinge pin receiver is configured to support SUV doors.

8. The versatile article support devices in claim 1 wherein the frame members are arranged architecture to support SUV doors on both sides of the second frame member.
